(19) United States
(12) Patent Application Publication
(10) Pub. No.: US 2026/0118184 A1
(43) Pub. Date: Apr. 30, 2026

(54) CONCRETE TEMPERATURE MONITORING SYSTEM AND CONCRETE STRUCTURE

(71) Applicants: CHINA ENERGY SCIENCE AND TECHNOLOGY RESEARCH INSTITUTE CO., LTD., NANJING, CHINA, Nanjing (CN); DONGGUAN INSTITUTE.SUN YAT-SEN UNIVERSITY, Dongguan (CN)

(72) Inventors: Yun XU, Nanjing (CN); Ke ZHUANG, Nanjing (CN); Qian ZHANG, Nanjing (CN); Xiaohuan MENG, Nanjing (CN); Ziqun WANG, Nanjing (CN); Haoliang WU, Dongguan (CN); Jiaming GU, Nanjing (CN); Xupeng SUI, Nanjing (CN); Boyin DING, Nanjing (CN); Jingming CAI, Nanjing (CN)

(21) Appl. No.: 19/192,390

(22) Filed: Apr. 29, 2025

(30) Foreign Application Priority Data
Oct. 24, 2024 (CN) 202411494550.3

(51) Int. Cl. G01K 7/02; G01K 1/024; G01K 3/14

(52) U.S. Cl. CPC G01K 7/02; G01K 1/024; G01K 3/14

(57) ABSTRACT

A concrete temperature monitoring system is provided. The monitoring system includes: a temperature sensing module including a plurality of geopolymer thermoelectric sheets embedded in concrete, each geopolymer thermoelectric sheet being configured to detect a temperature difference of the concrete and generate and output a temperature voltage signal based on the temperature difference of the concrete, each geopolymer thermoelectric sheet including a thermoelectric particle made of a functional material and a base material, the functional material including bismuth antimonide or bismuth selenide, and the base material including river sand, a cementitious material, an alkali activator, and bismuth telluride powder; a data collection module configured to receive and forward the temperature voltage signal; and an on-site monitoring and forwarding module configured to determine the temperature difference of the concrete based on the temperature voltage signal and perform on-site monitoring on the temperature difference of the concrete in real time.

### CROSS-REFERENCE TO RELATED APPLICATION

This application is based on and claims priority to China Patent Application No. 202411494550.3, filed on Oct. 24, 2024, the entire contents of which are incorporated herein by reference.

### FIELD

The present disclosure relates to the technical field of concrete temperature detection, and in particular, to a concrete temperature monitoring system and a concrete structure.

### BACKGROUND

With the rapid rise of construction of urban infrastructures such as large-span bridges, high-rise buildings, nuclear power plants, and reservoir dams, mass concrete is widely used as a vital structural component. Reducing temperature cracks in the mass concrete to the maximum extent is an important link in ensuring overall safety of the urban infrastructures. With the continuous deepening of people's understanding of mass concrete, more and more experts and scholars believe that it is necessary to introduce certain temperature control and monitoring measures during mass concrete construction.

In the existing technology, temperature sensors such as thermometers, thermocouples, or optical fiber sensors are generally used for temperature detection, which have problems such as difficult wiring, poor reliability, a low automation degree, and inability to effectively perform long-term monitoring, failing to satisfy the need for temperature control and monitoring of mass concrete in infrastructures such as bridges.

### SUMMARY

In view of the technical problems of difficult wiring, poor reliability, a low automation degree, and inability to effectively perform long-term monitoring in the existing temperature control and monitoring means, the present disclosure provides a concrete temperature monitoring system and a concrete structure. By using this concrete temperature monitoring system, intelligent monitoring of collection, early warning, management and analysis of a concrete temperature can be achieved, improving the informatization level of temperature control and monitoring of the mass concrete. Moreover, the concrete temperature monitoring system performs accurate temperature monitoring and has high reliability, facilitating long-term effective monitoring of the mass concrete.

In order to achieve the above-mentioned objects, a first aspect of the present disclosure provides a concrete temperature monitoring system. The concrete temperature monitoring system includes: a temperature sensing module including a plurality of geopolymer thermoelectric sheets embedded in concrete, in which each of the plurality of geopolymer thermoelectric sheets is configured to detect a temperature difference of the concrete and generate and output a temperature voltage signal based on the temperature difference of the concrete, each of the plurality of geopolymer thermoelectric sheets includes a thermoelectric particle made of a functional material and a base material, the functional material including bismuth antimonide or bismuth selenide, and the base material including river sand, a cementitious material, an alkali activator, and bismuth telluride powder; a data collection module in communication with the temperature sensing module and configured to receive the temperature voltage signal transmitted from each of the plurality of geopolymer thermoelectric sheets of the temperature sensing module and forward the temperature voltage signal; and an on-site monitoring and forwarding module in communication with the data collection module and configured to receive the temperature voltage signal forwarded from the data collection module, determine the temperature difference of the concrete based on the temperature voltage signal, and perform on-site monitoring on the temperature difference of the concrete in real time.

Further, the concrete temperature monitoring system further includes: a transmission module in communication with the on-site monitoring and forwarding module and configured to forward the temperature voltage signal; and a remote monitoring module in communication with the transmission module and configured to receive the temperature voltage signal forwarded from the transmission module, determine the temperature difference of the concrete based on the temperature voltage signal, and remotely monitor the temperature difference of the concrete in real time.

Further, the temperature sensing module is in communication with the data collection module through a ZigBee network.

Further, the thermoelectric particle includes a P-type thermoelectric particle and an N-type thermoelectric particle. The functional material includes the bismuth antimonide in response to the thermoelectric particle being the P-type thermoelectric particle, and the functional material includes the bismuth selenide in response to the thermoelectric particle being the N-type thermoelectric particle.

Further, each of the plurality of geopolymer thermoelectric sheets includes a plurality of P-type thermoelectric particles and a plurality of N-type thermoelectric particles. The plurality of P-type thermoelectric particles and the plurality of N-type thermoelectric particles are alternately connected in series with each other.

Further, a weight ratio of the river sand to the cementitious material ranges from 1:2 to 1:4; a weight ratio of a total weight of the river sand and the cementitious material to the alkali activator ranges from 100:20 to 100:35; and a weight ratio of the total weight of the river sand and the cementitious material to the bismuth telluride powder ranges from 100:20 to 100:40.

Further, the cementitious material includes 70-90 wt % of metakaolin, 5-20 wt % of slag, and 5-10 wt % of silica fume.

Further, the slag has a specific surface area ranging from 600 m²/kg to 800 m²/kg and a residue on 45 μm square-hole sieve smaller than 1%, and a total content of alumina and silica in the slag is greater than or equal to 50 wt %; and the silica fume has a particle size ranging from 0.1 μm to 0.3 μm and a specific surface area ranging from 15000 m²/kg to 30000 m²/kg.

Further, the alkali activator includes a mixed solution of a strong alkali solution and a sodium silicate solution. A weight ratio of the strong alkali solution to the sodium silicate solution ranges from 3:6 to 3:8.

A second aspect of that present disclosure provides a concrete structure. The concrete structure includes the concrete temperature monitoring system as described above.

Through the technical solutions provided by the present disclosure, the present disclosure at least has the following technical effects.

The concrete temperature monitoring system of the present disclosure includes a temperature sensing module, a data collection module, and an on-site monitoring and forwarding module that are in communication with each other sequentially. The temperature sensing module includes a plurality of geopolymer thermoelectric sheets embedded in concrete. Each of the plurality of geopolymer thermoelectric sheets is configured to detect a temperature difference of the concrete and generate and output a temperature voltage signal based on the temperature difference of the concrete. Each of the plurality of geopolymer thermoelectric sheets includes a thermoelectric particle made of a functional material and a base material. The functional material includes bismuth antimonide or bismuth selenide, and the base material includes river sand, a cementitious material, an alkali activator, and bismuth telluride powder. The thermoelectric particle has similar materials to the concrete, and can be embedded in the concrete and integrated with the concrete. The thermoelectric particle has high ductility and is capable of extending with deformation of the concrete. Moreover, the thermoelectric particle has a high compressive strength, and is capable of detecting the concrete temperature for a long time. Moreover, the thermoelectric particle has high electrical conductivity, improving accuracy of concrete temperature detection. The data collection module receives the temperature voltage signal transmitted from each geopolymer thermoelectric sheet of the temperature sensing module and forwards the temperature voltage signal. The on-site monitoring and forwarding module receives the temperature voltage signal forwarded from the data collection module, determines the temperature difference of the concrete based on the temperature voltage signal, and performs on-site monitoring on the temperature difference of the concrete in real time. By using the concrete temperature monitoring system according to the present disclosure, intelligent monitoring of collection, early warning, management and analysis of the concrete temperature can be achieved, improving the informatization level of temperature control and monitoring of the mass concrete. Moreover, the concrete temperature monitoring system performs accurate temperature monitoring and has high reliability, and the detection device has good ductility, facilitating long-term effective monitoring of the mass concrete.

Other features and advantages of the present disclosure will be described in detail in the following specific implementation parts.

### BRIEF DESCRIPTION OF THE DRAWINGS

The drawings are used for providing a further understanding of embodiments of the present disclosure, and constitute a part of the specification. In addition, the drawings are used for explaining the embodiments of the present disclosure together with the following specific implementations, rather than constituting limitations to the embodiments of the present disclosure, in the drawings:

FIG. 1 is a schematic diagram of a concrete temperature monitoring system provided by an embodiment of the present disclosure;

FIG. 2 is a schematic diagram of a geopolymer thermoelectric sheet in a concrete temperature monitoring system provided by an embodiment of the present disclosure; and

FIG. 3 illustrates a temperature development curve of a middle-layer measuring point in a concrete temperature monitoring system provided by an embodiment of the present disclosure.

### DESCRIPTION OF REFERENCE NUMERALS IN THE DRAWINGS

1—Temperature sensing module; 2—Data collection module; 3—On-site monitoring and forwarding module; 4—Transmission module; 5—Remote monitoring module; 6—Geopolymer thermoelectric sheet; 7—P-type thermoelectric particle; 8—N-type thermoelectric particle; 9—Ceramic upper substrate; 10—Ceramic lower substrate; 11—Wire; 12—Sending module.

### DETAILED DESCRIPTION

Specific implementations of the embodiments of the present disclosure will be described in detail below with reference to the accompanying drawings. It should be understood that the specific implementations described herein are used for illustration and explanation of the embodiments of the present disclosure only, and are not intended to limit the embodiments of the present disclosure.

It should be noted that, the embodiments in the present disclosure and the features in the embodiments may be combined with each other in the case of no conflict.

In the present disclosure, unless otherwise stated, orientation words such as “up, down, top, bottom” are usually descriptive words for directions shown in the drawings or for mutual position relationships of various components in a vertical, perpendicular, or gravitational direction.

As mentioned above, existing temperature sensors such as thermometers, thermocouples, or optical fiber sensors for temperature detection have problems such as difficult wiring, poor reliability, a low automation degree, and inability to effectively perform long-term monitoring, failing to satisfy the need for temperature control and monitoring of mass concrete in infrastructures such as bridges. To solve the above problem, a concrete temperature monitoring system is provided, which is described in detail below with reference to the drawings.

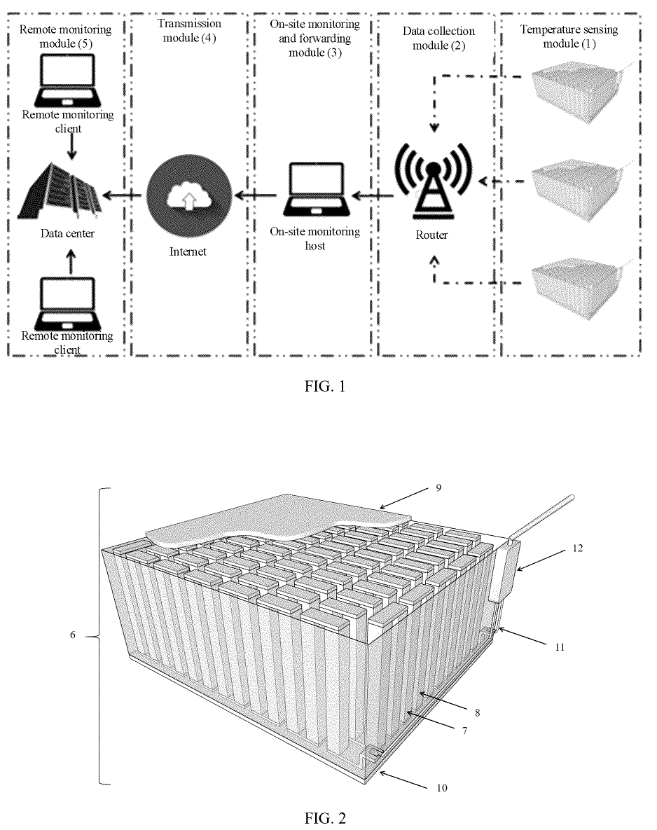

Referring to FIG. 1, a first aspect of the embodiments of the present disclosure provides a concrete temperature monitoring system. The concrete temperature monitoring system includes a temperature sensing module 1, a data collection module 2, and an on-site monitoring and forwarding module 3. The temperature sensing module 1 includes a plurality of geopolymer thermoelectric sheets 6 embedded in concrete. Each of the plurality of geopolymer thermoelectric sheets 6 is configured to detect a temperature difference of the concrete and generate and output a temperature voltage signal based on the temperature difference of the concrete. Each of the plurality of geopolymer thermoelectric sheets 6 includes a thermoelectric particle made of a functional material and a base material. The functional material includes bismuth antimonide or bismuth selenide, and the base material includes river sand, a cementitious material, an alkali activator, and bismuth telluride powder. The data collection module 2 is in communication with the temperature sensing module 1 and configured to receive the temperature voltage signal transmitted from each of the plurality of geopolymer thermoelectric sheets 6 of the temperature sensing module 1 and forward the temperature voltage signal. The on-site monitoring and forwarding module 3 is in communication with the data collection module 2 and configured to receive the temperature voltage signal forwarded from the data collection module 2, determine the temperature difference of the concrete based on the temperature voltage signal, and perform on-site monitoring on the temperature difference of the concrete in real time.

In the embodiments of the present disclosure, the concrete temperature monitoring system includes a temperature sensing module 1, a data collection module 2, and an on-site monitoring and forwarding module 3 that are in communication with each other sequentially. The temperature sensing module 1 includes a plurality of geopolymer thermoelectric sheets 6, and the plurality of geopolymer thermoelectric sheets 6 may be embedded in the concrete to detect the temperature difference of the concrete, convert the temperature difference of the concrete into voltage, then form the temperature voltage signal, and transmit the signal wirelessly to the data collection module 2. The function of the geopolymer thermoelectric sheet 6 to convert the temperature difference of the concrete into voltage mainly depends on the thermoelectric particle arranged inside the geopolymer thermoelectric sheet 6. The thermoelectric particle is made of the functional material and the base material. The functional material includes bismuth antimonide or bismuth selenide, and the base material includes river sand, a cementitious material, an alkali activator, and bismuth telluride powder. The thermoelectric particle has similar materials to the concrete, and can be embedded in the concrete and integrated with the concrete. The thermoelectric particle has high ductility and is capable of extending with deformation of the concrete. Moreover, the thermoelectric particle has a high compressive strength, and is capable of detecting the concrete temperature for a long time. Moreover, the thermoelectric particle has high electrical conductivity, improving accuracy of concrete temperature detection.

The data collection module 2 includes a router. After receiving the temperature voltage signals of the plurality of geopolymer thermoelectric sheets 6 of the temperature sensing module 1 through a wireless network, the data collection module 2 forwards the temperature voltage signals to the on-site monitoring and forwarding module 3. The on-site monitoring and forwarding module 3 is capable of converting the temperature voltage signals into temperature differences of the concrete to achieve concrete temperature monitoring. The on-site monitoring and forwarding module 3 includes a wireless data receiver, an on-site monitoring host, a router, and a power module. Mass concrete temperature monitoring software may be installed on the on-site monitoring host to convert the temperature voltage signals into the temperature differences of the concrete, display the concrete temperature in real time, and issue an early warning for the concrete temperature.

With the concrete temperature monitoring system according to the present disclosure, intelligent monitoring of collection, early warning, management and analysis of the concrete temperature can be achieved, improving the informatization level of temperature control and monitoring of the mass concrete. Moreover, the concrete temperature monitoring system performs accurate temperature monitoring and has high reliability, and the detection device has good ductility, facilitating long-term monitoring of the mass concrete.

The concrete temperature monitoring system further includes: a transmission module 4 in communication with the on-site monitoring and forwarding module 3 and configured to forward the temperature voltage signal; and a remote monitoring module 5 in communication with the transmission module 4 and configured to receive the temperature voltage signal forwarded from the transmission module 4, determine the temperature difference of the concrete based on the temperature voltage signal, and remotely monitor the temperature difference of the concrete in real time.

In an embodiment of the present disclosure, if remote monitoring is required, the on-site monitoring and forwarding module 3 may transmit the temperature voltage signal to the transmission module 4, and the transmission module 4 forwards the temperature voltage signal to the remote monitoring module 5. The remote monitoring module 5 converts the temperature voltage signal into the temperature difference of the concrete and remotely monitors the temperature difference of the concrete in real time. The temperature voltage signal is transmitted between the transmission module 4 and the remote monitoring module 5 through a network established by an internet service provider (such as China Unicom, China Mobile, and China Telecom, etc.).

The remote monitoring module 5 is provided with a data server, which collects and stores a plurality of temperature voltage signals transmitted from a construction site. A temperature control expert may log in to the data server through a remote client and browse the temperature difference of the concrete, so as to obtain temperature control data timely, and provide a temperature control suggestion.

With the concrete temperature monitoring system provided by the present disclosure, remote monitoring of the concrete temperature can be realized, which is convenient for the temperature control expert to obtain the temperature control data timely and provide the temperature control suggestion.

Further, the temperature sensing module 1 is in communication with the data collection module 2 through a ZigBee network.

In an embodiment of the present disclosure, the temperature sensing module 1 is in communication with the data collection module 2 through the ZigBee network. In this embodiment, data transmission of the ZigBee network may be realized by using a CC2530 chip. The ZigBee network is suitable for large-scale network deployment and can realize the temperature monitoring of mass concrete. A ZigBee device has low power consumption and is capable of operating for a long time when powered by a battery. Moreover, the ZigBee network has strong self-organizing and self-healing capabilities, and can be dynamically established and maintained, improving transmission reliability of concrete temperature data.

Further, the thermoelectric particle includes a P-type thermoelectric particle and an N-type thermoelectric particle. The functional material includes the bismuth antimonide in response to the thermoelectric particle being the P-type thermoelectric particle, and the functional material includes the bismuth selenide in response to the thermoelectric particle being the N-type thermoelectric particle.

Further, the geopolymer thermoelectric sheet 6 includes a plurality of P-type thermoelectric particles and a plurality of N-type thermoelectric particles. The plurality of P-type thermoelectric particles and the plurality of N-type thermoelectric particles are alternately connected in series with each other.

In an embodiment of the present disclosure, the thermoelectric particle includes a P-type thermoelectric particle and an N-type thermoelectric particle. The functional material includes the bismuth antimonide in response to the thermoelectric particle being the P-type thermoelectric particle, and the functional material includes the bismuth selenide in response to the thermoelectric particle being the N-type thermoelectric particle. A plurality of P-type thermoelectric particles and a plurality of N-type thermoelectric particles are alternately connected in series with each other and arranged in the geopolymer thermoelectric sheet 6.

Referring to FIG. 2, in a possible implementation, the geopolymer thermoelectric sheet 6 includes a P-type thermoelectric particle 7, an N-type thermoelectric particle 8, a ceramic upper substrate 9, a ceramic lower substrate 10, a wire 11, and a sending module 12. Each of the P-type thermoelectric particle 7 and the N-type thermoelectric particle 8 is an elongated cuboid with a head end and a tail end in a length direction of the cube. The P-type thermoelectric particles 7 and the N-type thermoelectric particles 8 are alternately arranged. The head end of a first P-type thermoelectric particle 7 is connected to the head end of a first N-type thermoelectric particle 8 through an electrode, and the tail end of the first N-type thermoelectric particle 8 is connected to the tail end of a second P-type thermoelectric particle 7 through an electrode, and so on until the last thermoelectric particle is connected, forming a thermoelectric particle group where the P-type thermoelectric particles 7 and the N-type thermoelectric particles 8 are alternately connected in series with each other. The thermoelectric particle group may sense the temperature difference of the concrete and convert the temperature difference into a temperature voltage. The ceramic upper substrate 9 is arranged above the electrode at the head end of the thermoelectric particle, and the ceramic lower substrate 10 is arranged below the electrode at the tail end of the thermoelectric particle. The ceramic upper substrate 9 and the ceramic lower substrate 10 serve as insulating media to prevent a short-circuit of the thermoelectric particle group. The wire 11 is welded to positive and negative ends of the thermoelectric particle group and is in communication with the sending module 12. The sending module 12 modulates the temperature voltage into radio waves and transmits the radio waves to the router of the data collection module 2, and then the router transmits the radio waves to the on-site monitoring and forwarding module 3 through multi-hop transmission.

Further, a weight ratio of the river sand to the cementitious material ranges from 1:2 to 1:4; a weight ratio of a total weight of the river sand and the cementitious material to the alkali activator ranges from 100:20 to 100:35; and a weight ratio of the total weight of the river sand and the cementitious material to the bismuth telluride powder ranges from 100:20 to 100:40.

Further, the cementitious material includes 70-90 wt % of metakaolin, 5-20 wt % of slag, and 5-10 wt % of silica fume.

Further, the slag has a specific surface area ranging from 600 m²/kg to 800 m²/kg and a residue on 45 μm square-hole sieve smaller than 1%, and a total content of alumina and silica in the slag is greater than or equal to 50 wt %; and the silica fume has a particle size ranging from 0.1 μm to 0.3 μm and a specific surface area ranging from 15000 m²/kg to 30000 m²/kg.

Further, the alkali activator includes a mixed solution of a strong alkali solution and a sodium silicate solution. A weight ratio of the strong alkali solution to the sodium silicate solution ranges from 3:6 to 3:8.

This ratio can not only improve the ductility of the thermoelectric particle, enabling the thermoelectric particle to extend with the deformation of the concrete, but also improve the compressive strength of the thermoelectric particle, enabling the thermoelectric particle to detect the concrete temperature for a long time, and also improve the electrical conductivity of the thermoelectric particle, improving the accuracy of concrete temperature detection.

Preparation of the geopolymer thermoelectric sheet includes the following steps S1 to S9.

At step S1, the metakaolin, slag, and silica fume are mixed, then bismuth telluride powder and the functional material are added, and the alkali activator is finally added.

At step S2, an intermediate material obtained in step S1 is transferred into a thermoelectric particle mold for curing, and then demolding and polishing are performed to obtain the thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then a two-layer mold is placed (an upper-layer mold may be turned up and down to fill P-type thermoelectric particles and N-type thermoelectric particles respectively, and a lower-layer mold is used to screen the P-type particles and the N-type particles, to ensure that the two types of particles are not mis-filled and are accurately positioned on a copper electrode of the ceramic substrate), one type of the thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to complete the preparation of the geopolymer thermoelectric sheet.

In a preferred implementation, the mixing in step S1 is performed by stirring, with a stirring speed ranging from 300 r/min to 500 r/min and a stirring duration ranging from 3 min to 5 min. In some embodiments, the stirring speed may be 300 r/min, 350 r/min, 400 r/min, 450 r/min, or 500 r/min, and the stirring duration may be 3 min, 4 min, or 5 min.

In a preferred implementation, a curing temperature in step S2 ranges from 10° C. to 30° C., and a curing duration ranges from 12 h to 36 h. In some embodiments, the curing temperature may be 10° C., 20° C., or 30° C., and the curing duration may be 12 h, 24 h, or 36 h.

In a first embodiment, a geopolymer thermoelectric sheet A1 is prepared through the following steps S1 to S10.

At step S1, river sand and a cementitious material are mixed by stirring at a speed of 400 r/min for 3 min, then bismuth telluride powder and a functional material are added, and an alkali activator is finally added.

A weight ratio of the river sand to the cementitious material is 1:4. In the cementitious material, a content of metakaolin is 70 wt %, a content of slag is 20 wt %, and a content of silica fume is 10 wt %. A weight ratio of a total weight of the river sand and the cementitious material to the bismuth telluride powder is 100:20. A weight ratio of the total weight of the river sand and the cementitious material to the alkali activator is 100:30. The alkali activator is obtained by mixing an 8 mol/L NaOH solution and a sodium silicate solution at a weight ratio of 3:7.

At step S2, an intermediate material obtained in step S1 is transferred into an electrode mold, cured at a temperature of 20° C. for 24 h, and then demolded and polished to obtain a thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then a two-layer mold is placed (an upper-layer mold may be turned up and down to fill P-type thermoelectric particles and N-type thermoelectric particles respectively, and a lower-layer mold is used to screen the P-type particles and the N-type particles to ensure that the two types of particles are not mis-filled and are accurately positioned on a copper electrode of the ceramic substrate), one type of thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to obtain the geopolymer thermoelectric sheet A1.

At step S10, the geopolymer thermoelectric sheet A1 is placed at a predetermined position to pour concrete.

In a second embodiment, a geopolymer thermoelectric sheet A2 is prepared through the following steps S1 to S10.

At step S1, river sand and a cementitious material are mixed by stirring at a speed of 400 r/min for 3 min, then bismuth telluride powder and a functional material are added, and an alkali activator is finally added.

A weight ratio of the river sand to the cementitious material is 1:4. In the cementitious material, a content of metakaolin is 70 wt %, a content of slag is 20 wt %, and a content of silica fume is 10 wt %. A weight ratio of a total weight of the river sand and the cementitious material to the bismuth telluride powder is 100:30. A weight ratio of the total weight of the river sand and the cementitious material to the alkali activator is 100:30. The alkali activator is obtained by mixing an 8 mol/L NaOH solution and a sodium silicate solution at a weight ratio of 3:7.

At step S2, an intermediate material obtained in step S1 is transferred into an electrode mold, cured at a temperature of 10° C. for 36 h, and then demolded and polished to obtain a thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then a two-layer mold is placed (an upper-layer mold may be turned up and down to fill P-type thermoelectric particles and N-type thermoelectric particles respectively, and a lower-layer mold is used to screen the P-type particles and the N-type particles to ensure that the two types of particles are not mis-filled and are accurately positioned on a copper electrode of a ceramic substrate), one type of thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to obtain the geopolymer thermoelectric sheet A2.

At step S10, the geopolymer thermoelectric sheet A2 is placed at a predetermined position to pour concrete.

In a third embodiment, a geopolymer thermoelectric sheet A3 is prepared through the following steps S1 to S10.

At step S1, river sand and a cementitious material are mixed by stirring at a speed of 400 r/min for 3 min, then bismuth telluride powder and a functional material are added, and an alkali activator is finally added.

A weight ratio of the river sand to the cementitious material is 1:4. In the cementitious material, a content of metakaolin is 70 wt %, a content of slag is 20 wt %, and a content of silica fume is 10 wt %. A weight ratio of a total weight of the river sand and the cementitious material to the bismuth telluride powder is 100:40. A weight ratio of the total weight of the river sand and the cementitious material to the alkali activator is 100:30. The alkali activator is obtained by mixing an 8 mol/L NaOH solution and a sodium silicate solution at a weight ratio of 3:7.

At step S2, an intermediate material obtained in step S1 is transferred into an electrode mold, cured at a temperature of 30° C. for 12 h, and then demolded and polished to obtain a thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then two layer of molds are placed (an upper-layer mold may be turned up and down to fill P-type thermoelectric particles and N-type thermoelectric particles respectively, and a lower-layer mold is used to screen the P-type particles and the N-type particles to ensure that the two types of particles are not mis-filled and are accurately positioned on a copper electrode of a ceramic substrate), one type of thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to obtain the geopolymer thermoelectric sheet A3.

At step S10, the geopolymer thermoelectric sheet A3 is placed at a predetermined position to pour concrete.

In a fourth embodiment, a geopolymer thermoelectric sheet A4 is prepared through the following steps S1 to S10.

At step S1, river sand and a cementitious material are mixed by stirring at a speed of 400 r/min for 3 min, then bismuth telluride powder and a functional material are added, and an alkali activator is finally added.

A weight ratio of the river sand to the cementitious material is 1:4. In the cementitious material, a content of metakaolin is 80 wt %, a content of slag is 20 wt %, and a content of silica fume is 10 wt %. A weight ratio of a total weight of the river sand and the cementitious material to the bismuth telluride powder is 100:30. A weight ratio of the total weight of the river sand and the cementitious material to the alkali activator is 100:30. The alkali activator is obtained by mixing an 8 mol/L NaOH solution and a sodium silicate solution at a weight ratio of 3:7.

At step S2, an intermediate material obtained in step S1 is transferred into an electrode mold, cured at a temperature of 20° C. for 24 h, and then demolded and polished to obtain a thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then a two-layer mold is placed (an upper-layer mold may be turned up and down to fill P-type thermoelectric particles and N-type thermoelectric particles respectively, and a lower-layer mold is used to screen the P-type particles and the N-type particles to ensure that the two types of particles are not mis-filled and are accurately positioned on a copper electrode of a ceramic substrate), one type of thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to obtain the geopolymer thermoelectric sheet A4.

At step S10, the geopolymer thermoelectric sheet A4 is placed at a predetermined position to pour concrete.

In a fifth embodiment, a geopolymer thermoelectric sheet A5 is prepared through the following steps S1 to S10.

At step S1, river sand and a cementitious material are mixed by stirring at a speed of 400 r/min for 3 min, then bismuth telluride powder and a functional material are added, and an alkali activator is finally added.

A weight ratio of the river sand to the cementitious material is 1:4. In the cementitious material, a content of metakaolin is 90 wt %, a content of slag is 5 wt %, and a content of silica fume is 5 wt %. A weight ratio of a total weight of the river sand and the cementitious material to the bismuth telluride powder is 100:30. A weight ratio of the total weight of the river sand and the cementitious material to the alkali activator is 100:30. The alkali activator is obtained by mixing an 8 mol/L NaOH solution and a sodium silicate solution at a weight ratio of 3:7.

At step S2, an intermediate material obtained in step S1 is transferred into an electrode mold, cured at a temperature of 30° C. for 24 h, and then demolded and polished to obtain a thermoelectric particle.

At step S3, a nickel layer of 6 μm to 8 μm is evenly electroplated on the thermoelectric particle obtained in step S2, and then a tin layer of 6 μm to 8 μm is electroplated, to metallize the surface of the thermoelectric particle.

At step S4, a copper-clad ceramic lower substrate is placed on a matching metal platform, lead-free solder is printed, then a two-layer mold is placed (an upper-layer mold may be turned up and down to fill P-type thermoelectric particles and N-type thermoelectric particles respectively, and a lower-layer mold is used to screen the P-type particles and the N-type particles to ensure that the two types of particles are not mis-filled and are accurately positioned on a copper electrode of a ceramic substrate), one type of thermoelectric particles is evenly sprinkled, and the mold is vibrated, making the thermoelectric particles accurately fall into designated positions.

At step S5, an upper layer of the mold is removed, excess thermoelectric particles are removed, the upper-layer mold and the lower-layer mold are detached, turned over to the other side, and put back onto the metal platform, and a filling process of the other type of thermoelectric particles is repeated.

At step S6, after all the particles are filled, a fixing mold is removed, and then the upper substrate is positioned through a groove of the metal platform and covered on an upper end of the thermoelectric particle.

At step S7, a prepared mask plate is used to evenly apply solder paste on the copper electrode and is removed, and then the previous method for filling the thermoelectric particle is used to fill and fix the thermoelectric particle.

At step S8, after the above-mentioned processes are completed, the entire device is placed on a heating platform and fixed, and then the temperature is raised to 350° C. to ensure that a temperature at the upper end of the particle reaches a melting temperature of the solder paste. After keeping the temperature for a period of time, the entire device together with the fixing mold is placed on an underwater heat-dissipation platform for cooling;

At step S9, the wire is welded to positive and negative ends, to obtain the geopolymer thermoelectric sheet A5.

At step S10, the geopolymer thermoelectric sheet A5 is placed at a predetermined position to pour concrete.

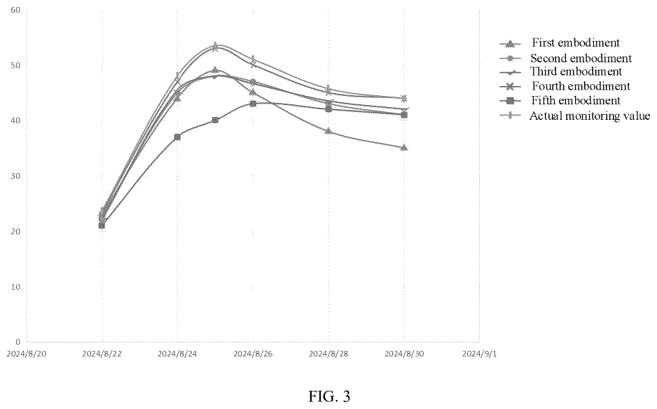

The geopolymer thermoelectric sheet obtained through the above five embodiments are respectively placed at a construction site for mass concrete pouring of a bridge cap and an anchor block. The concrete temperature monitoring system is used throughout the process to perform temperature monitoring on the mass concrete of the bridge cap and the anchor block. As shown in FIG. 3, temperature monitoring data is recorded for a total of 168 h. A physical performance test is performed on the embodiments, and data shown in Table 1 is obtained. ZT=S²*T*σ/K, where S is a seebeck coefficient, σ is the electrical conductivity, k is the thermal conductivity, and T is the temperature. It can be seen from Table 1 that the compressive strength, the electrical conductivity, the seebeck coefficient, a ZT value, and an output voltage of the geopolymer thermoelectric sheets of the five embodiments are all good.

TABLE 1

| | Compressive | Electrical | Seebeck | | Output |
|---|---|---|---|---|---|
| Serial | strength | conductivity | coefficient | ZT | voltage |
| number | (MPa) | (10⁴ S/m) | (μV/K) | value | (V) |
| First | 45 | 6.12 | 192.6 | 0.361 | 0.5 |
| embodiment | | | | | |
| Second | 49 | 7.11 | 202.5 | 0.414 | 0.6 |
| embodiment | | | | | |
| Third | 51 | 6.75 | 198 | 0.387 | 0.6 |
| embodiment | | | | | |
| Fourth | 60 | 7.65 | 210 | 0.463 | 0.7 |
| embodiment | | | | | |
| Fifth | 40 | 5.58 | 188 | 0.349 | 0.4 |
| embodiment | | | | | |

A second aspect of the present disclosure provides a concrete structure. The concrete structure includes the concrete temperature monitoring system as described above.

The preferred embodiments of the present disclosure are described in detail above with reference to the accompanying drawings. However, the present disclosure is not limited to specific details in the above embodiments. Many simple variants can be made to the technical solutions of the present disclosure within the scope of the technical concept of the present disclosure. These simple variants belong to the protection scope of the present disclosure.

In addition, it should be noted that the various specific technical features described in the above specific embodiments can be combined in any suitable manner without contradictions. In order to avoid unnecessary repetitions, various possible combinations will not be described separately in the present disclosure.

In addition, different embodiments of the present disclosure can be combined arbitrarily, as long as the combination is within the idea of the present disclosure, and the combination should also be regarded as the content disclosed in the present disclosure.

What is claimed is:

1. A concrete temperature monitoring system, comprising:
a temperature sensing module comprising a plurality of geopolymer thermoelectric sheets embedded in concrete, wherein each of the plurality of geopolymer thermoelectric sheets is configured to detect a temperature difference of the concrete and generate and output a temperature voltage signal based on the temperature difference of the concrete, each of the plurality of geopolymer thermoelectric sheets comprises a thermoelectric particle made of a functional material and a base material, the functional material comprising bismuth antimonide or bismuth selenide, and the base material comprising river sand, a cementitious material, an alkali activator, and bismuth telluride powder;
a data collection module in communication with the temperature sensing module and configured to receive the temperature voltage signal transmitted from each of the plurality of geopolymer thermoelectric sheets of the temperature sensing module and forward the temperature voltage signal; and
an on-site monitoring and forwarding module in communication with the data collection module and configured to receive the temperature voltage signal forwarded from the data collection module, determine the temperature difference of the concrete based on the temperature voltage signal, and perform on-site monitoring on the temperature difference of the concrete in real time.

2. The concrete temperature monitoring system according to claim 1, further comprising:
a transmission module in communication with the on-site monitoring and forwarding module and configured to forward the temperature voltage signal; and
a remote monitoring module in communication with the transmission module and configured to receive the temperature voltage signal forwarded from the transmission module, determine the temperature difference of the concrete based on the temperature voltage signal, and remotely monitor the temperature difference of the concrete in real time.

3. The concrete temperature monitoring system according to claim 1, wherein the temperature sensing module is in communication with the data collection module through a ZigBee network.

4. The concrete temperature monitoring system according to claim 1, wherein the thermoelectric particle comprises a P-type thermoelectric particle and an N-type thermoelectric particle, the functional material comprising the bismuth antimonide in response to the thermoelectric particle being the P-type thermoelectric particle, and the functional material comprising the bismuth selenide in response to the thermoelectric particle being the N-type thermoelectric particle.

5. The concrete temperature monitoring system according to claim 4, wherein each of the plurality of geopolymer thermoelectric sheets comprises a plurality of P-type thermoelectric particles and a plurality of N-type thermoelectric particles, the plurality of P-type thermoelectric particles and the plurality of N-type thermoelectric particles being alternately connected in series with each other.

6. The concrete temperature monitoring system according to claim 1, wherein:
a weight ratio of the river sand to the cementitious material ranges from 1:2 to 1:4;
a weight ratio of a total weight of the river sand and the cementitious material to the alkali activator ranges from 100:20 to 100:35; and
a weight ratio of the total weight of the river sand and the cementitious material to the bismuth telluride powder ranges from 100:20 to 100:40.

7. The concrete temperature monitoring system according to claim 1, wherein the cementitious material comprises 70-90 wt % of metakaolin, 5-20 wt % of slag, and 5-10 wt % of silica fume.

8. The concrete temperature monitoring system according to claim 7, wherein the slag has a specific surface area ranging from 600 m²/kg to 800 m²/kg and a residue on 45 μm square-hole sieve smaller than 1%, and a total content of alumina and silica in the slag is greater than or equal to 50 wt %; and
the silica fume has a particle size ranging from 0.1 μm to 0.3 μm and a specific surface area ranging from 15000 m²/kg to 30000 m²/kg.

9. The concrete temperature monitoring system according to claim 1, wherein the alkali activator comprises a mixed solution of a strong alkali solution and a sodium silicate solution, wherein a weight ratio of the strong alkali solution to the sodium silicate solution ranges from 3:6 to 3:8.

10. A concrete structure, comprising a concrete temperature monitoring system, the concrete temperature monitoring system comprising:
a temperature sensing module comprising a plurality of geopolymer thermoelectric sheets embedded in concrete, wherein each of the plurality of geopolymer thermoelectric sheets is configured to detect a temperature difference of the concrete and generate and output a temperature voltage signal based on the temperature difference of the concrete, each of the plurality of geopolymer thermoelectric sheets comprises a thermoelectric particle made of a functional material and a base material, the functional material comprising bismuth antimonide or bismuth selenide, and the base material comprising river sand, a cementitious material, an alkali activator, and bismuth telluride powder;
a data collection module in communication with the temperature sensing module and configured to receive the temperature voltage signal transmitted from each of the plurality of geopolymer thermoelectric sheets of the temperature sensing module and forward the temperature voltage signal; and
an on-site monitoring and forwarding module in communication with the data collection module and configured to receive the temperature voltage signal forwarded from the data collection module, determine the temperature difference of the concrete based on the temperature voltage signal, and perform on-site monitoring on the temperature difference of the concrete in real time.

11. The concrete structure according to claim 10, further comprising:
a transmission module in communication with the on-site monitoring and forwarding module and configured to forward the temperature voltage signal; and
a remote monitoring module in communication with the transmission module and configured to receive the temperature voltage signal forwarded from the transmission module, determine the temperature difference of the concrete based on the temperature voltage signal, and remotely monitor the temperature difference of the concrete in real time.

12. The concrete structure according to claim 10, wherein the temperature sensing module is in communication with the data collection module through a ZigBee network.

13. The concrete structure according to claim 10, wherein the thermoelectric particle comprises a P-type thermoelectric particle and an N-type thermoelectric particle, the functional material comprising the bismuth antimonide in response to the thermoelectric particle being the P-type thermoelectric particle, and the functional material comprising the bismuth selenide in response to the thermoelectric particle being the N-type thermoelectric particle.

14. The concrete structure according to claim 13, wherein each of the plurality of geopolymer thermoelectric sheets comprises a plurality of P-type thermoelectric particles and a plurality of N-type thermoelectric particles, the plurality of P-type thermoelectric particles and the plurality of N-type thermoelectric particles being alternately connected in series with each other.

15. The concrete structure according to claim 10, wherein:
a weight ratio of the river sand to the cementitious material ranges from 1:2 to 1:4;
a weight ratio of a total weight of the river sand and the cementitious material to the alkali activator ranges from 100:20 to 100:35; and
a weight ratio of the total weight of the river sand and the cementitious material to the bismuth telluride powder ranges from 100:20 to 100:40.

16. The concrete structure according to claim 10, wherein the cementitious material comprises 70-90 wt % of metakaolin, 5-20 wt % of slag, and 5-10 wt % of silica fume.

17. The concrete structure according to claim 16, wherein the slag has a specific surface area ranging from 600 m²/kg to 800 m²/kg and a residue on 45 μm square-hole sieve smaller than 1%, and a total content of alumina and silica in the slag is greater than or equal to 50 wt %; and
the silica fume has a particle size ranging from 0.1 μm to 0.3 μm and a specific surface area ranging from 15000 m²/kg to 30000 m²/kg.

18. The concrete structure according to claim 10, wherein the alkali activator comprises a mixed solution of a strong alkali solution and a sodium silicate solution, wherein a weight ratio of the strong alkali solution to the sodium silicate solution ranges from 3:6 to 3:8.
